(19) United States
(12) Patent Application Publication
(10) Pub. No.: US 2011/0182570 A1
(43) Pub. Date: Jul. 28, 2011

(54) THREE-DIMENSIONAL VIDEO IMAGING DEVICE

(75) Inventor: YU-CHOU YEH, TAOYUAN COUNTY (TW)

(73) Assignee: J TOUCH CORPORATION, TAOYUAN COUNTY (TW)

(21) Appl. No.: 12/757,417

(22) Filed: Apr. 9, 2010

(30) Foreign Application Priority Data
Jan. 25, 2010 (TW) 099101920

(51) Int. Cl. G03B 35/00

(52) U.S. Cl. 396/326

(57) ABSTRACT

A three-dimensional (3D) video imaging device includes a lens array unit, a substrate and a display unit. The lens array unit includes a plurality of lenses, and a plurality of light-shielding elements are installed on either a top surface or a bottom surface of the substrate and arranged with an interval apart from each other and corresponding to respective gaps between the lenses. The substrate is disposed above or under the lens array unit, or the substrate is integrally formed with the lens array unit, or the substrate is omitted. The light-shielding elements are installed directly onto a light entry surface of the lens array unit to simplify the stacked structure and the manufacturing process. The 3D video imaging device can achieve the effects of preventing stray lights, enhancing 3D image sharpness, and maintaining a high-resolution display.

### BACKGROUND OF THE INVENTION

1. Field of the Invention

The present invention relates to a video imaging field, and more particularly to a three-dimensional (3D) video imaging device capable of preventing stray lights and improving 3D image sharpness.

2. Description of the Related Art

In present existing 3D image display technologies, binocular disparity is generally used for receiving different images by a viewer's left and right eyes, such that the viewer's brain can combine the images into a 3D image. Basically, the 3D display technologies are mainly divided into two types, respectively: a stereoscopic display and an autostereoscopic display, and the stereoscopic display includes a polarization type and a time division type, and a naked eye 3D display technology is mainly divided into a lenticular lens and a barrier according to a display structure. The aforementioned two types of display structures have both advantages and disadvantages, wherein the lenticular lens is composed of many slender convex lens arranged continuously in an axial direction, and the principle of light refraction is used for producing different views to the left and right eyes. Compared with the barrier type, a light refraction is used to achieve the effect of splitting light in order to minimize light loss and maintain high brightness. However, edges of the lens structure have limitations on refraction, and thus the refracting effect is poor. If there is a manufacturing error of the lenticular lens, stray lights will be produced due to an uneven lens surface, and a portion of the 3D image may become blurred, and thus the overall 3D image display effect is affected adversely. On the other hand, the barrier type uses a row of barriers for restricting lights of certain angles from projecting, and only allowing viewing images of certain angles to be transmitted to the viewer's left and right eyes to produce a 3D image. Compared with the lenticular lens, the barrier type provides a sharper image for a single eye, but its structural characteristic will lower the overall image brightness and resolution.

To overcome the aforementioned problem, a “display device and lenticular sheet of the display device and a method thereof” as disclosed in U.S. Pat. Application No. 20090262418 is provided, wherein the display device comprises a pixel array display panel, and a lenticular lens layer, wherein each lens of the lenticular lens is composed of first, second and third surfaces, and a light exit surface of the lens comes with a stair-like structure instead of the traditional circular arc structure to overcome the issue of mutual light interference and improving the distribution of brightness.

In addition, an “improvement of lenticular design by applying light blocking feature” as disclosed in World Intellectual Property Office Pat. Application No. WO2007039868 is provided, wherein a 3D video display device comprises: a lens device having a plurality of lenticular lenses, and the lens structure has a first surface facing an incident light source, a second surface facing an exit light, and a light absorption repeating pattern, and the light absorption repeating pattern is disposed on the second surface of the lens structure, and the light absorption repeating pattern is applied directly on a black stripe coating layer in a groove between the lens structures. Although the structure can overcome the problem of stray lights, the manufacturing method is too complicated for a practical application.

### SUMMARY OF THE INVENTION

In view of the shortcomings of the prior art, the inventor of the present invention based on years of experience in the related industry to conduct extensive researches and experiments, and finally developed a 3D imaging device in accordance with the present invention.

Therefore, it is an objective of the present invention to provide a 3D video imaging device capable of producing a sharp 3D image.

Another objective of the present invention is to provide a 3D video imaging device capable of reducing the stray lights of a 3D image.

A further objective of the present invention is to provide a 3D video imaging device that will not reduce the brightness of a 3D image.

To achieve the foregoing objectives, the present invention provides a 3D video imaging device comprising a lens array unit, a substrate having a plurality of light-shielding elements on a surface of the substrate, and a display unit.

The lens array unit includes a plurality of lenses, and each lens has a light entry surface and a light exit surface, and the lenses are arranged in a horizontal direction, such that an image displayed by the display unit can be reflected in a predetermined direction by the lenses and transmitted to a viewer's left and right eyes to produce a 3D image.

The substrate is made of a transparent sheet material selected from the collection of glass, polyethylene terephthalate (PET), polycarbonate (PC), polyethylene (PE), polyvinyl chloride (PVC), polypropylene (PP), polystyrene (PS), polymethylmethacrylate (PMMA), and cycloolefin copolymer (COC).

The substrate includes a plurality of light-shielding elements installed on one of the surfaces of the substrate, such as the top surface of the substrate or the bottom surface of the substrate, and the light-shielding elements can be formed on the surface of the substrate by using a physical vapor deposition method such as spluttering or by attaching a thin film having a plurality of light-shielding elements onto the surface of the substrate.

The light-shielding elements are disposed above the light exit surface of the lens array unit or under the light entry surface of the lens array unit.

The light-shielding elements are installed at respective gaps between each lens and another lens for reducing or eliminating stray lights.

To simplify the manufacturing process and reduce the thickness of the stacked structure, the substrate can be integrally formed with the lens array unit, or the substrate is omitted directly and the plurality of light-shielding elements are formed directly onto the light entry surface of the lens array unit by the spluttering or thin film attachment method.

The display unit is installed under the lens array unit and the substrate for displaying a multiple of images that produce the 3D image, and the multiple of images pass through the lens array unit and the light shielding elements, such that the images can be transmitted to a viewer's left and right eyes to produce the 3D image effect, and after the light shielding elements filter unnecessary stray lights of the images, the 3D image seen by the viewer will become sharper, and the overall brightness of the displayed 3D image will not be reduced.

### BRIEF DESCRIPTION OF THE DRAWINGS

FIG. 1 is a perspective view of a first preferred embodiment according to the present invention;

FIG. 2 is a cross-sectional side view of a first preferred embodiment according to the present invention;

FIG. 3 is a cross-sectional side view of a second preferred embodiment according to the present invention;

FIG. 4 is a cross-sectional side view of a third preferred embodiment according to the present invention;

FIG. 5 is a cross-sectional side view of a fourth preferred embodiment according to the present invention; and

FIG. 6 is a cross-sectional side view of a fifth preferred embodiment according to the present invention.

### DETAILED DESCRIPTION OF THE PREFERRED EMBODIMENTS

The technical characteristics of the present invention will become apparent with the detailed description of the preferred embodiments and the illustration of the related drawings.

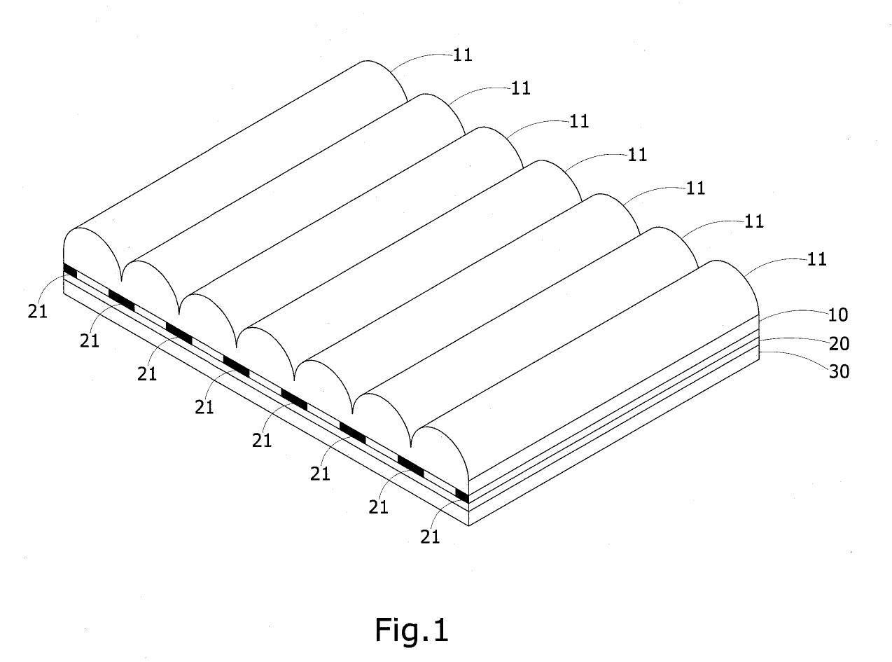

With reference to FIGS. 1 to 3 for a perspective view and a cross-sectional side view of a first preferred embodiment and a cross-sectional side view of a second preferred embodiment of the present invention respectively, a 3D video imaging device of the invention comprises a lens array unit 10, a substrate 20 and a display unit 30.

The lens array unit 10 includes a plurality of lenses 11 arranged in a horizontal direction.

The substrate 20 is disposed at a position under the lens array unit 10 and made of a transparent sheet material selected from the collection of glass, polyethylene terephthalate (PET), polycarbonate (PC), polyethylene (PE), polyvinyl chloride (PVC), polypropylene (PP), polystyrene (PS), polymethylmethacrylate (PMMA), and cycloolefin copolymer (COC).

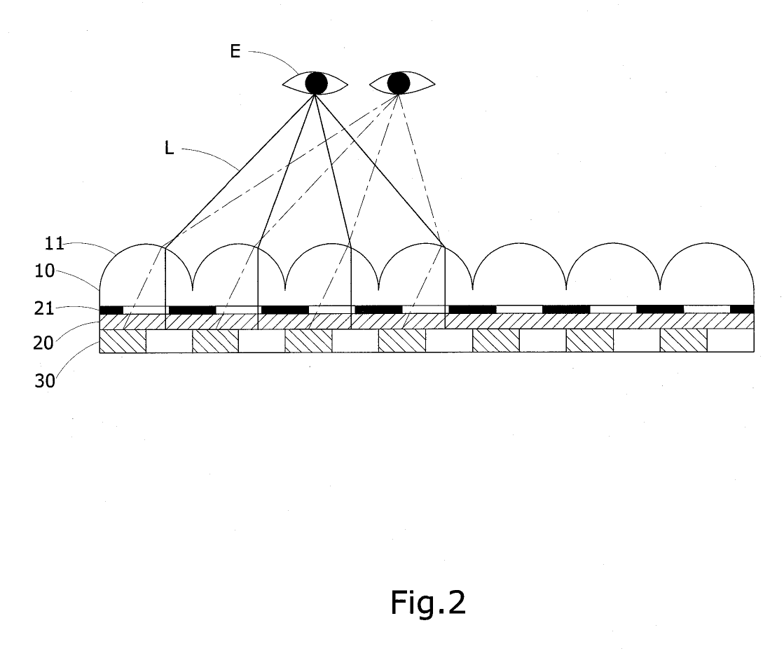

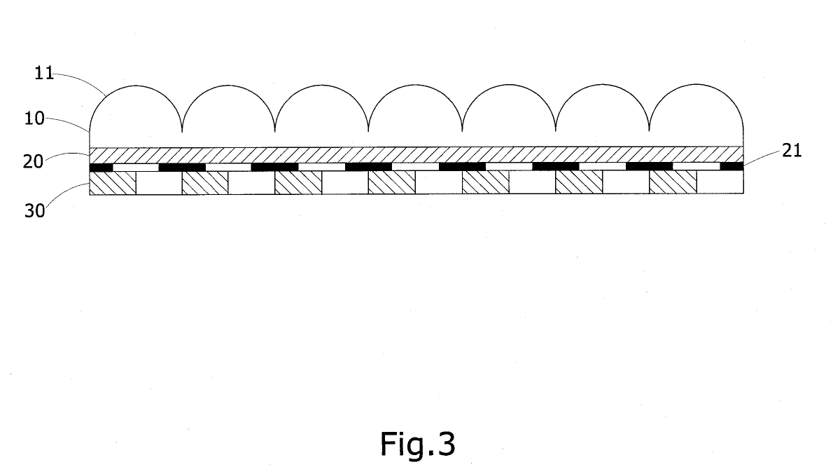

A plurality of light-shielding elements 21 are installed on a surface of the substrate 20, wherein the light-shielding elements 21 can be installed on the top surface of the substrate 20 as shown in FIG. 2, or installed on the bottom surface of the substrate 20 as shown in FIG. 3, and the light-shielding elements 21 are installed at positions corresponding to respective gaps between each lens 11 and another lens 11 of the lens array unit 10, or installed at edges of the lenses 11, wherein the light-shielding elements 21 are installed with an interval apart from each other and in the same horizontal direction of the installed lens array unit 10.

The light-shielding elements 21 are installed on the substrate 20 by a physical vapor deposition method such as spluttering, or by attaching a thin film having a plurality of light-shielding elements onto a surface of the substrate 20.

The display unit 30 is installed under the lens array unit 10 and the substrate 20 for displaying a multiple of images that can produce a 3D image.

The display unit 30 can be a cathode ray tube (CRT), a liquid crystal display (LCD), a plasma display panel (PDP), a surface conduction electron-emitter display (SED), a field emission display (FED), a vacuum fluorescent display (VFD), an organic light-emitting diode (OLED) or an e-Paper.

In the 3D video imaging principle of the present invention, a multiple of images L are processed by the display unit 30, and the refraction principle of the lenses 11 is adopted for projecting a light source of the images in a predetermined direction into both left and right eyes of a viewer E, such that the viewer's brain can produce a 3D image effect. However, the lenses have drawbacks of their optical structure, and thus a gap between lenses or an edge of a lens (both positions are situated at a wave trough) has a poor refraction effect, such that the direction of a light reflected from these positions will be difficult to control and the stray lights may be produced. To overcome the shortcoming of this optical structure, a light-shielding element 21 is usually installed at the gap of the lenses for filtering the stray lights to provide a sharp image without distortions, while maintaining a high brightness of the displayed 3D image.

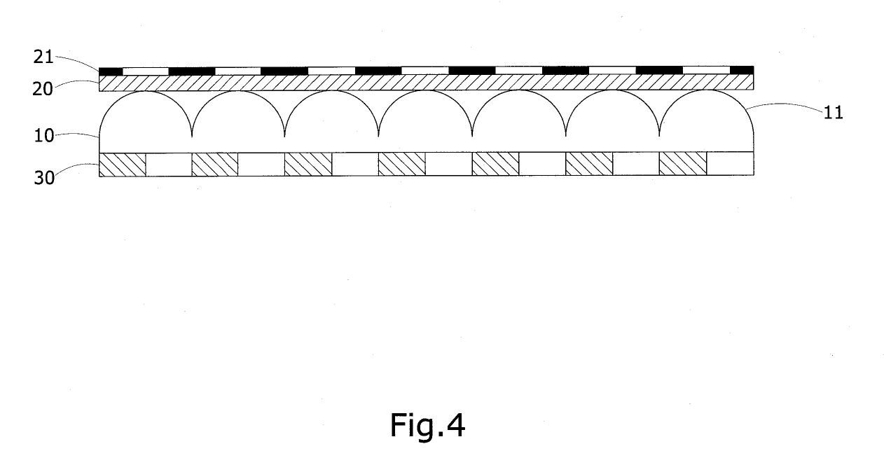

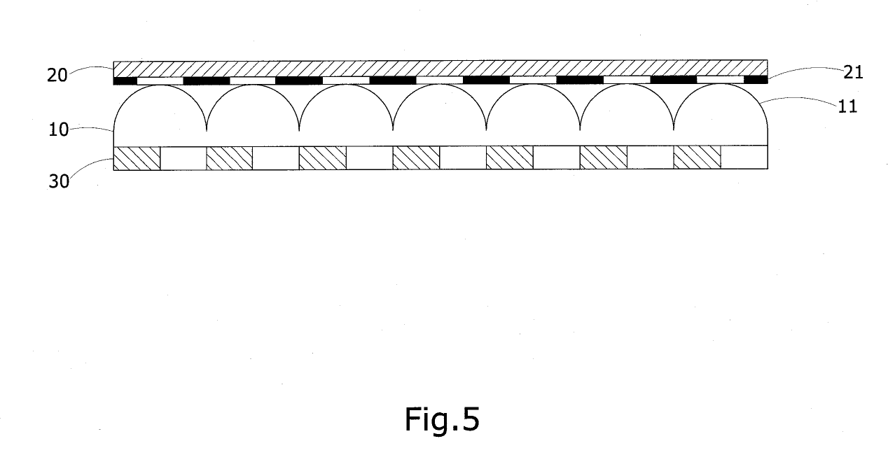

With reference to FIGS. 4 and 5 for cross-sectional side views of a third preferred embodiment and a fourth preferred embodiment of the present invention respectively, a 3D video imaging device of the invention comprises a lens array unit 10, a substrate 20 and a display unit 30.

The lens array unit 10 includes a plurality of lenses 11 arranged in a horizontal direction.

Unlike the aforementioned first and second preferred embodiments, the substrate 20 is installed at a position above the lens array unit 10 and made of a transparent sheet material selected from the collection of glass, polyethylene terephthalate (PET), polycarbonate (PC), polyethylene (PE), polyvinyl chloride (PVC), polypropylene (PP), polystyrene (PS), polymethylmethacrylate (PMMA), and cycloolefin copolymer (COC).

A plurality of light-shielding elements 21 are installed on a surface of the substrate 20, wherein the light-shielding elements 21 can be installed on the top surface of the substrate 20 as shown in FIG. 4, or installed on the bottom surface of the substrate 20 as shown in FIG. 5, and the light-shielding elements 21 are installed at positions corresponding to respective gaps between each lens 11 and another lens 11 of the lens array unit 10, or installed at edges of the lenses 11, and the light-shielding elements 21 are installed with an interval apart from each other and in the same horizontal direction of the installed lens array unit 10.

The light-shielding elements 21 are installed on the substrate 20 by a physical vapor deposition method such as spluttering, or by attaching a thin film having a plurality of light-shielding elements onto a surface of the substrate 20.

The display unit 30 is installed under the lens array unit 10 and the substrate 20 for displaying a multiple of images that can produce a 3D image.

The display unit 30 can be a cathode ray tube (CRT), a liquid crystal display (LCD), a plasma display panel (PDP), a surface conduction electron-emitter display (SED), a field emission display (FED), a vacuum fluorescent display (VFD), an organic light-emitting diode (OLED) or an e-Paper.

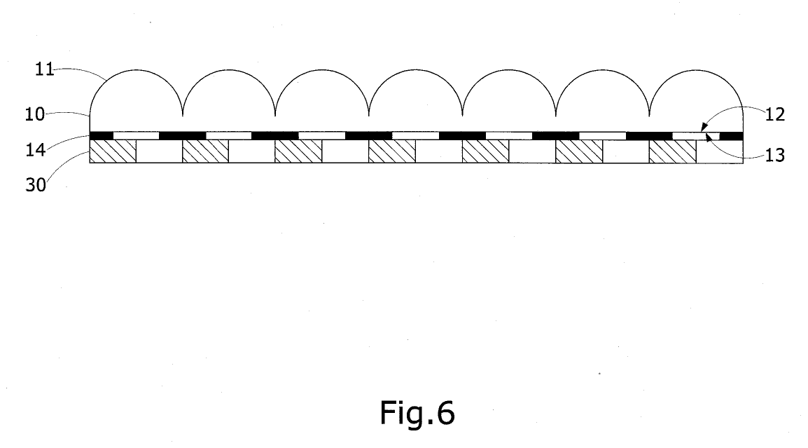

To simplify the manufacturing process and reduce the thickness of the stacked structure, the substrate 20 can be integrally formed with the lens array unit 10, or the substrate 20 can be omitted. With reference to FIG. 6 for a cross-sectional side view of a fifth preferred embodiment of the present invention, the 3D video imaging device comprises a lens array unit 10, a plurality of light-shielding elements 14 and a display unit 30, wherein the lens array unit 10 includes a plurality of lenses 11, and each lens 11 has a light exit surface 12 and a light entry surface 13, and the light-shielding elements 14 are installed on a light entry surface 13 of the lens array unit 10, and the display unit 30 is installed under the lens array unit 10 and the light-shielding elements 14.

The light-shielding elements 14 are formed onto the light entry surface 13 of the lens array unit 10 by a physical vapor deposition method such as spluttering, or by attaching a thin film having a plurality of light-shielding elements 14 onto the light entry surface 13 of the lens array unit 10, and the light-shielding elements 14 are installed at positions corresponding to respective gaps between a lens 11 and another lens 11 of the lens array unit 10, or installed at edges of the lenses 11.

The present invention improves over the prior art and complies with patent application requirements, and thus is duly filed for the patent application.

While the invention has been described by device of specific embodiments, numerous modifications and variations could be made thereto by those generally skilled in the art without departing from the scope and spirit of the invention set forth in the claims.

What is claimed is:

1. A three-dimensional (3D) video imaging device, comprising:
a lens array unit, having a plurality of lenses;
a substrate, installed under the lens array unit, and having a plurality of light-shielding elements installed on one of the surfaces of the substrate; and
a display unit, installed under the substrate, for displaying a multiple of images that can produce a 3D image.

2. The 3D video imaging device of claim 1, wherein the substrate is made of a transparent sheet material selected from the collection of glass, polyethylene terephthalate (PET), polycarbonate (PC), polyethylene (PE), polyvinyl chloride (PVC), polypropylene (PP), polystyrene (PS), polymethylmethacrylate (PMMA), and cycloolefin copolymer (COC).

3. The 3D video imaging device of claim 1, wherein the light-shielding elements are installed on the top surface of the substrate by a spluttering process.

4. The 3D video imaging device of claim 1, wherein the light-shielding elements correspond to respective gaps between the lenses to form a thin film for attaching the top surface of the substrate.

5. The 3D video imaging device of claim 1, wherein the light-shielding elements correspond to respective gaps between the lenses to form a thin film for attaching the bottom surface of the substrate.

6. The 3D video imaging device of claim 1, further comprising a thin film having a plurality of light-shielding elements and attached onto the bottom surface of the substrate.

7. The 3D video imaging device of claim 1, wherein the light-shielding elements are installed at positions corresponding to respective gaps between the lenses.

8. The 3D video imaging device of claim 5, wherein the substrate and the lens array unit are integrally formed.

9. The 3D video imaging device of claim 6, wherein the substrate and the lens array unit are integrally formed.

10. A three-dimensional (3D) video imaging device, comprising:
a lens array unit, having a plurality of lenses;
a substrate, installed above the lens array unit, and having a plurality of light-shielding elements installed on one of the surfaces of the substrate; and
a display unit, installed under the lens array unit, for displaying a multiple of images that can produce a 3D image.

11. The 3D video imaging device of claim 10, wherein the substrate is made of a transparent sheet material selected from the collection of glass, polyethylene terephthalate (PET), polycarbonate (PC), polyethylene (PE), polyvinyl chloride (PVC), polypropylene (PP), polystyrene (PS), polymethylmethacrylate (PMMA), and cycloolefin copolymer (COC).

12. The 3D video imaging device of claim 10, wherein the light-shielding elements are installed on the top surface of the substrate by a spluttering process.

13. The 3D video imaging device of claim 10, wherein the light-shielding elements correspond to respective gaps between the lenses to form a thin film for attaching the top surface of the substrate.

14. The 3D video imaging device of claim 10, wherein the light-shielding elements correspond to respective gaps between the lenses to form a thin film for attaching the bottom surface of the substrate.

15. The 3D video imaging device of claim 10, further comprising a thin film having a plurality of light-shielding elements and attached onto the bottom surface of the substrate.

16. The 3D video imaging device of claim 10, wherein the light-shielding elements are installed at positions corresponding to respective gaps between the lenses.

17. A three-dimensional (3D) video imaging device, comprising:
a lens array unit, having a plurality of lenses, and each lens having a light entry surface and a light exit surface;
a plurality of light-shielding elements, installed on the light entry surface of the lens array unit; and
a display unit, installed above the light-shielding elements, for displaying a multiple of images that can produce a 3D image.

18. The 3D video imaging device of claim 17, wherein the light-shielding elements are installed on the light entry surface of the lens array unit by a spluttering process.

19. The 3D video imaging device of claim 17, wherein the light-shielding elements correspond to respective gaps between the lenses to form a thin film for attaching the light entry surface of the lens array unit.

20. The 3D video imaging device of claim 17, wherein the plurality of light-shielding elements are installed at positions corresponding to respective gaps between the lenses.
